(19) United States
(12) Patent Application Publication
(10) Pub. No.: US 2016/0372083 A1
(43) Pub. Date: Dec. 22, 2016

(54) FACILITATING INCREASED USER EXPERIENCE AND EFFICIENT POWER PERFORMANCE USING INTELLIGENT SEGMENTATION ON FLEXIBLE DISPLAY SCREENS

(71) Applicant: INTEL CORPORATION, Santa Clara, CA (US)

(72) Inventors: SHAHAR TAITE, kfar saba (IL); IGOR LJUBUNCIC, Chiswick (GB); TOMER RIDER, Naahryia (IL)

(73) Assignee: INTEL CORPORATION, Santa Clara, CA (US)

(21) Appl. No.: 14/742,977

(22) Filed: Jun. 18, 2015

(51) Int. Cl. G09G 5/14; G06F 3/0484; G06F 3/0488; G06F 3/01; G06F 1/16; G06F 3/041

(52) U.S. Cl. CPC G09G 5/14; G06F 1/1652; G06F 3/0412; G06F 3/04883; G06F 3/013; G06F 3/012; G06F 1/1694; G06F 3/017; G06F 1/1677; G06F 1/1647; G06F 3/0414; G06F 3/0484; G06F 3/04886; G06F 2200/1637; G06F 2203/04803; G09G 2300/026; G09G 2330/021; G06F 2203/04102; G06F 2203/04106

(57) ABSTRACT

A mechanism is described for facilitating increased user experience and efficient power performance using intelligent segmentation on flexible display screens according to one embodiment. A method of embodiments, as described herein, includes detecting a plurality of segments on a flexible display screen, and detecting, via one or more capturing/sensing components, at least one of a touch, a lack of touch, a movement, and a gesture relative to the plurality of segments. The method may further include interpreting the touch to determine one or more active segments or one or more inactive segments of the plurality of segments, and turning-off the one or more inactive segments and keep active the one or more active segments of the plurality of segments of the flexible display screen.

### FIELD

Embodiments described herein generally relate to computers. More particularly, embodiments relate to facilitating increased user experience and efficient power performance using intelligent segmentation on flexible display screens.

### BACKGROUND

It is well known that display screens are the biggest power/battery consumers of all components in computing devices. Further, with the growth in computing technology, display screens, including flexible display screens, are also gaining popularity and noticeable traction in becoming a mainstream technology as seen being employed in various devices, such as televisions, wearable devices, smartphones, tablet computers, etc., and even as standalone flexible displays. However, conventional techniques treat flexible displays as single displays and are severely limited in their application and do not provide for any feasible technique for conservation of power without compromising user experience.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing an intelligent display flexibility mechanism according to one embodiment.

FIG. 2 illustrates an intelligent display flexibility mechanism according to one embodiment.

FIG. 3A illustrates a bending scenario of a flexible display screen according to one embodiment.

FIG. 3B illustrates a bending scenario of a flexible display screen according to one embodiment.

FIG. 3C illustrates a bending scenario of a flexible display screen according to one embodiment.

FIG. 3D illustrates a bending scenario of a flexible display screen according to one embodiment.

FIG. 3E illustrates a natural holding gesture.

FIG. 4 illustrates a method for facilitating increased user experience and efficient power performance using intelligent segmentation on flexible display screens according to one embodiment.

FIG. 5 illustrates computer system suitable for implementing embodiments of the present disclosure according to one embodiment.

FIG. 6 illustrates computer environment suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel technique for improving user experience while saving power by extending battery life through the intelligent use of the flexibility of flexible display devices. In one embodiment, an active segment of a flexible display device may be identified such that this active segment (e.g., a part the user is using) is kept running, while the inactive segment (e.g., a part the user is not using) is shutdown, as will be further described throughout this document. It is to be noted that terms like “segment”, “part”, “area”, and “portion” may be used interchangeably throughout this document. Similarly, terms like “fold”, “bend”, “flex”, “curve”, and “roll” may be used interchangeably throughout this document. Further, throughout this document, “flexible display screen” may be interchangeably referred to as “flexible screen”, “flexible device”, or “flexible display”.

Embodiments provide for proactively identifying various curves and bends on a flexible screen to dynamically segment the flexible screen into multiple areas with each area serving as a screen, including one or more active areas and one or more inactive areas. In one embodiment, a single flexible screen may be used as having different active display areas providing different contents by proactively detecting and using the flexible screen's various curves and bends. Similarly, in one embodiment, one or more inactive areas may be shut down to conserve the power at least without having to compromise the user experience.

It is contemplated that flexible displays are regarded as the next game changers for mobile devices and with the evolving technology of displays, there is and will continue to be an increasing need to deal with certain challenges (relating to power consumption, user interface, unintentional touches, etc.) to support the next generation of eco-system usages and devices.

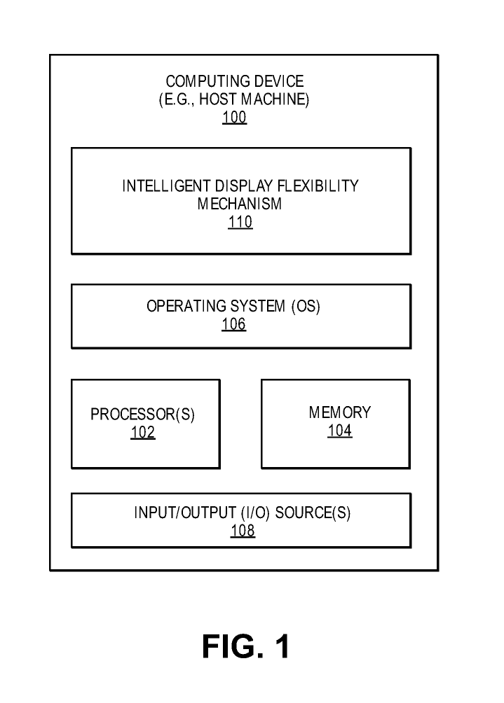

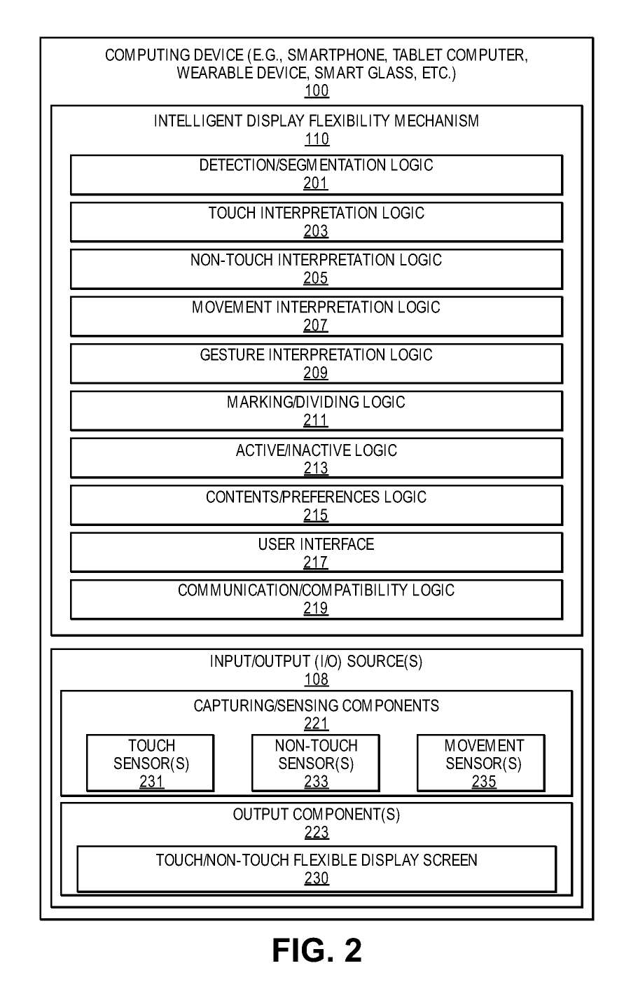

FIG. 1 illustrates a computing device 100 employing an intelligent display flexibility mechanism 110 according to one embodiment. Computing device 100 servers a host machine for hosting intelligent display flexibility mechanism (“flexibility mechanism”) 110 that may include any number and type of components, as illustrated in FIG. 2, to facilitate intelligent detection and use of flexibility in display screens to enhance user experience while conserving power as will be further described throughout this document.

Computing device 100 may include any number and type of communication devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, smart windshields, smart windows, head-mounted displays (HMDs) (e.g., optical head-mounted display (e.g., wearable glasses, head-mounted binoculars, gaming displays, military headwear, etc.), and other wearable devices (e.g., smartwatches, bracelets, smartcards, jewelry, clothing items, etc.), etc.

It is contemplated and to be noted that embodiments are not limited to computing device 100 and that embodiments may be applied to and used with any form or type glass that is used for viewing purposes, such as smart windshields, smart windows (e.g., smart window by Samsung®, etc.), and/or the like. Similarly, it is contemplated and to be noted that embodiments are not limited to any particular type of computing device and that embodiments may be applied and used with any number and type of computing devices; however, throughout this document, the focus of the discussion may remain on wearable devices, such as wearable glasses, etc., which are used as examples for brevity, clarity, and ease of understanding.

In some embodiments, computing device 100 may include a large(r) computing system (e.g., server computer, desktop computer, laptop computer, etc.), such that a flexible display screen may be part of this large(r) computing system where the flexible display screen may be a part or an extension screen of a main display screen, where the main screen itself may be flexible or static.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as one or more touchable and/or non-touchable flexible display screen(s) (e.g., foldable screens, roll-able screens, bendable screens, curve-able screens, etc.), touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a group of individuals using or having access to computing device 100.

FIG. 2 illustrates an intelligent display flexibility mechanism 110 according to one embodiment. In one embodiment, flexibility mechanism 110 may include any number and type of components, such as (without limitation): detection/segmentation logic 201; touch interpretation logic 203; non-touch interpretation logic 205; movement interpretation logic 207; gesture interpretation logic 209; marking/dividing logic 211; active/inactive logic 213; contents/preferences logic 215; user interface 217; and communication/compatibility logic 219.

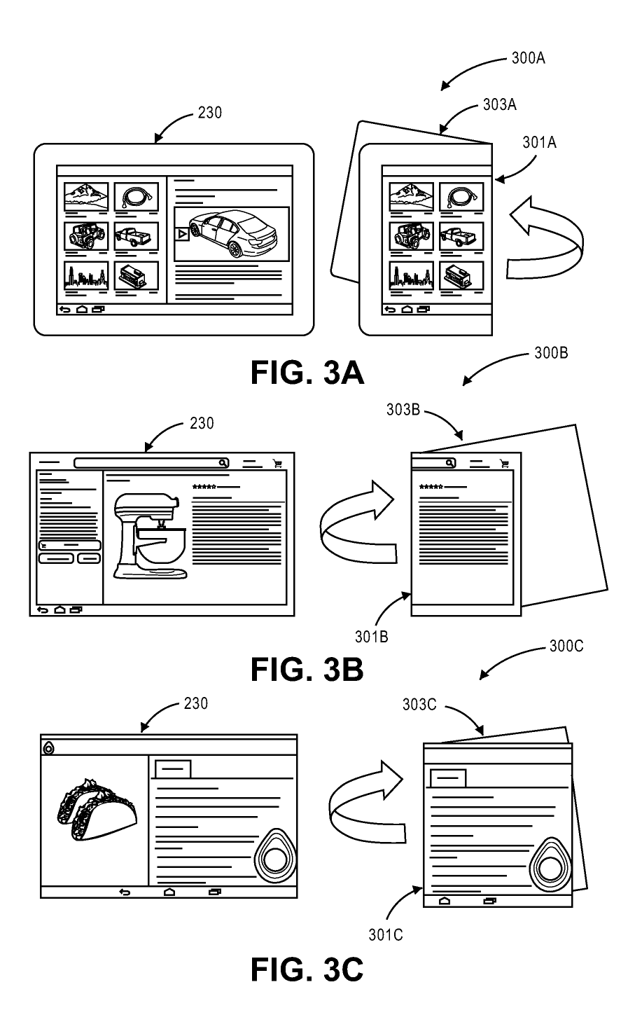

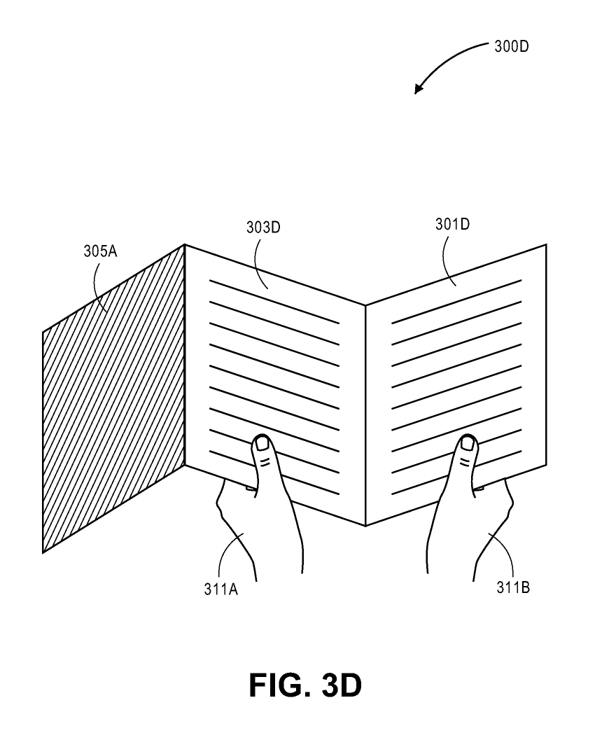

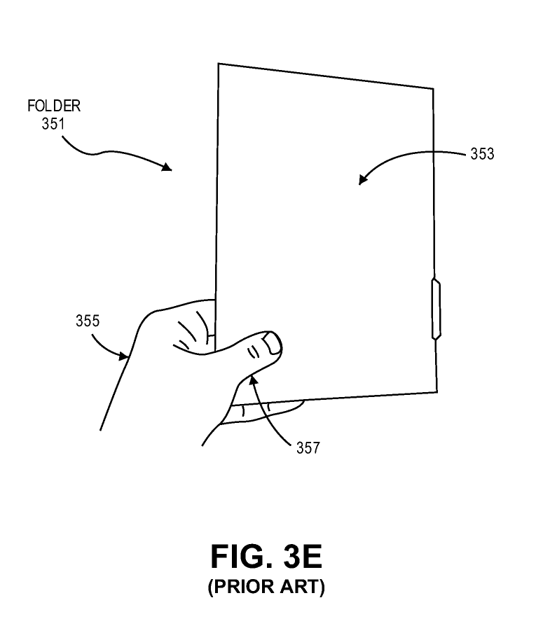

Computing device 100 (e.g., handheld device, wearable device, smart window, etc.) may further include any number and type of other components, such as capturing/sensing components 221 (e.g., capacitor touch sensors (“touch sensors”) 231, current delta non-touch sensors (“non-touch sensors”) 233 (e.g., delta-sigma modulator, etc.), cameras, microphones, etc.), output components 223 (e.g., touch/non-touch flexible display screen 230, such as folding screen, bending screen, rolling screen, curving screen, etc.), etc. Although embodiments are not limited to any particular form of flexibility (e.g., rolling, curving, bending, etc.) of flexible screen 230, for the sake of brevity, clarify, and ease of understanding, various folding patterns, such as those of FIGS. 3A-3D, are primarily discussed throughout most of the rest of this document.

It is contemplated that flexible screen 230 may not be part of computing device 100 and that it may be a standalone display screen and may be in communication with computing device 100. For example and in one embodiment, computing device 100 may be a smart window or a handheld device having flexible display screen 230 that may include one or more of a roll-able screen that is capable of being rolled in one or more ways, foldable screen that is capable of being folded in one or more ways (such as folding scenarios 300A-D of FIGS. 3A-D), bendable screen that is capable of being bent in one or more ways, curve-able screens that is capable of being curved in one or more ways, etc., and further, flexible display screen 230 may be a touch screen or a non-touch screen.

As aforementioned with reference to FIG. 1, in some embodiments, computing device 100 may include a large(r) computing system (e.g., server computer, desktop computer, laptop computer, etc.), such that flexible display screen 230 may be part of this large(r) computing system where flexible display screen 230 may be a part or an extension screen of a main display screen, where the main screen itself may be flexible or static.

Further, for example and in one embodiment, capturing/sensing components 221 may include any number and type of components, such as touch sensors 231, non-touch sensors 233, movement sensors 235 (e.g., accelerometer, gyroscope, etc.), two-dimensional (2D) cameras, three-dimensional (3D) cameras, camera sensors, microphones, Red Green Blue (RGB) sensors, etc., for performing detection and sensing tasks for segmentation of flexible screen 230, such as facilitating activation/inactivation of one or more segments of flexible screen 230 for enhancing user experience and saving battery power, as will be further described below.

Capturing/sensing components 221 may further include any number and type of capturing/sensing devices, such as one or more sending and/or capturing devices (e.g., 2D/3D cameras, camera sensors, RGB sensors, microphones, biometric sensors, chemical detectors, signal detectors, wave detectors, force sensors (e.g., accelerometers), gyroscopes, illuminators, etc.) that may be used for capturing any amount and type of visual data, such as images (e.g., photos, videos, movies, audio/video streams, etc.), and non-visual data, such as audio streams (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), environmental/weather conditions, maps, etc. It is contemplated that “sensor” and “detector” may be referenced interchangeably throughout this document. It is further contemplated that one or more capturing/sensing components 221 may further include one or more supporting or supplemental devices for capturing and/or sensing of data, such as illuminators (e.g., infrared (IR) illuminator), light fixtures, generators, sound blockers, etc.

It is further contemplated that in one embodiment, capturing/sensing components 221 may further include any number and type of sensing devices or sensors (e.g., linear accelerometer) for sensing or detecting any number and type of contexts (e.g., estimating horizon, linear acceleration, etc., relating to a mobile computing device, etc.). For example, capturing/sensing components 221 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); gravity gradiometers to study and measure variations in gravitation acceleration due to gravity, etc.

For example, capturing/sensing components 221 may further include (without limitations): audio/visual devices (e.g., 2D/3D cameras, microphones, speakers, etc.); context-aware sensors (e.g., temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device), etc.; global positioning system (GPS) sensors; resource requestor; and trusted execution environment (TEE) logic. TEE logic may be employed separately or be part of resource requestor and/or an I/O subsystem, etc.

Computing device 100 may further include one or more output components 223 to remain in communication with one or more capturing/sensing components 221 and one or more components of flexibility mechanism 110 to facilitate displaying of images, playing or visualization of sounds, displaying visualization of fingerprints, presenting visualization of touch, smell, and/or other sense-related experiences, etc. For example and in one embodiment, output components 223 may include (without limitation) one or more of light sources, display devices or screens, audio speakers, bone conducting speakers, olfactory or smell visual and/or non/visual presentation devices, haptic or touch visual and/or non-visual presentation devices, animation display devices, biometric display devices, X-ray display devices, audio/video projectors, projection areas, etc.

Computing device 100 may be in communication with one or more repositories or databases over one or more networks, where any amount and type of data (e.g., real-time data, historical contents, metadata, resources, policies, criteria, rules and regulations, upgrades, etc.) may be stored and maintained. Similarly, computing device 100 may be in communication with any number and type of other computing devices, such as HMDs, wearable devices, smart windows, mobile computers (e.g., smartphone, a tablet computer, etc.), desktop computers, laptop computers, etc., over one or more communication channels or networks (e.g., Cloud network, the Internet, intranet, Internet of Things (“IoT”), proximity network, Bluetooth, etc.).

It is contemplated that computing device 100 may include one or more software applications (e.g., device applications, hardware components applications, business/social application, websites, etc.) in communication with flexibility mechanism 110, where a software application may offer one or more user interfaces (e.g., web user interface (WUI), graphical user interface (GUI), touchscreen, etc.) to work with and/or facilitate one or more operations or functionalities of flexibility mechanism 110.

In one embodiment, computing device 100 may include a flexible display screen-based device, such as a handheld device, a wearable device, a smart windows, laptop computer, desktop computer, etc., having at least one flexible display screen which may be touchable or non-touchable. Further, flexible display screen 230 may be of any size, such as a micro-screen mounted on a smartcard or a smart bracelet to a very large screen that is wall-mounted or billboard-mounted, etc., based on any number and type of techniques or technologies, such as (without limitation) electrochromic, photochromic, thermochromic, or suspended particles, etc. It is contemplated and to be noted that embodiments are not limited to any particular number and type of flexible screen 230 being standalone or device-based, small or large, single layered or block of layers, or depending on any particular type or form of technology, etc.

It is contemplated that flexible screen 230 may be segmented at one or more locations such that flexible screen 230 may be folded, bent, curved, rolled, etc., as detected by detection/segmentation logic 201. For example and in one embodiment, detection/segmentation logic 201 may be used to facilitate sensing and detecting of one or more segments of flexible screen 230 by identifying any number of curves, bends, folds, etc., using one or more components of flexibility mechanism 110, such as touch logic 203, non-touch logic 205, movement logic 207, gesture logic 209, etc.

In one embodiment, in case of flexible screen 230 being a touch-based screen, touch logic 203 may be used to facilitate touch sensor 231 to detect any changes in the running charge of flexible screen 230 at an axis when flexible screen is bent (such as folded, rolled, curved, etc.) at the axis, because when flexible screen 230 is bent at a certain axis, the charge around that axis is altered. For example, under normal circumstances, such as when flexible screen 230 remains unbent, the polarity charge of flexible screen 230 continues to run in constant current streams until flexible screen 230 is bent at an axis which can lead to changes in pixel proximity around the axis area which further leads to differences or modifications in the current around that axis area. In one embodiment, as aforementioned, touch logic 203 facilitates touch sensor 231 to detect and identify such changes in the current or charges around the axis area of flexible screen 230.

In another embodiment, in case of flexible screen 230 being a non-touch screen, non-touch logic 205 may be used to facilitate non-touch sensor 233 to track and extract any indication of flexible screen 230 being bent (such as folded, rolled, curved, etc.) by measuring small current changes over a period of time in a specific area of flexible screen 230, where specific area includes an axis area at which flexible screen 230 is bent. For example, the change in the current may indicate screen bending of flexible screen 230 around an axis by measuring charge differences on the bent axis as facilitated by non-touch logic 205 using non-touch sensor 233.

In one embodiment, movement logic 207 may work with one or more movement sensors 235 to detect any movement relating to flexible screen 230, such as the act of folding of flexible screen 230 by the user may be identified by a combination of multiple movement sensors 235 (e.g., accelerometer, gyroscope, etc.) installed in various areas of flexible screen 230 which may then be used by movement logic 207 to recognize which of the sides or segments of the folded flexible screen 230 (as shown in FIGS. 3A-3D) may be darkened or regarded as inactive to save battery power. For example, if flexible screen 230 is folded like a folder, the segment of flexible screen 230 that is moved (or experiences movement) as opposed to the segment that is kept still (or remains unmoved) may be regarded by active/inactive logic 213 as the inactive size and is darkened, while the segment that remains still may be regarded as active and kept turned-on for the user to use. It is contemplated that terms “side” and “segment” are referenced interchangeably throughout this document.

Similarly, in one embodiment, one or more touch sensors 231 and more non-touch sensors 233 may be used to determine the user's particular touch or lack thereof on various segments of flexible screen 230 which may then be interpreted by gesture interpretation logic 209 as whether the gesture is to be regarded as a natural gesture by the user, such as a natural way to hold a folder or, in this case, folded flexible screen 230, to further determine which segments may be turned-off or kept turned-on, etc. For example, as illustrated with regard to FIG. 3E, when a person holds a piece of paper or folder, or something else of similar nature and form, etc., it would be regarded as a natural holding pattern for the user have their thumb on the active side of the paper (such as the side the user is reading or paying attention), but have most of the fingers of the hand behind the paper or on the inactive side of it.

In one embodiment, this aforementioned natural hold pattern and other such natural patterns may be detected using any number of sensors of capturing/sensing components 221, such as touch sensors 231, non-touch sensors 233, etc., and interpreted with a great deal of confidence by gesture interpretation logic 209 to then allow active/inactive logic 213 to use this interpretation by gesture interpretation logic 209 to regard one or more segments of flexible screen 230 as active or inactive, such as darkening the inactive or unused part (such as the segment sensing more fingers of the user) of flexible screen 230, while keeping turned-on the active or used part of flexible screen 230, such as the part experiencing the user's thumb.

Similarly, in some embodiments, movement logic 207 and/or gesture logic 209 may be used to interpret other forms of movements, gestures, etc., with respect to the user and/or flexible screen 230, computing device 100, etc., as determined by one or more sensors/components of capturing/sensing components 221. For example, in one embodiment, various components, such as cameras, a gaze tracking system, a head tracking mechanism, etc., of capturing/sensing components 221 may be used to track activities relating to the user and/or flexible screen 230 may be detected which may then be interpreted. For example, in one embodiment, the camera or the gaze tracking system may detect and track the movement and/or focus of the user's eyes with respect to various segments/sides of flexible screen 230 which may the be used by movement logic 207 and/or gesture logic 209 to determine or interpret one or more active segments of flexible screen 230, such as those segments that the user is gazing is determined to be the active segments and kept turned-on, while those one or more segments that are not the focus of the user's eyes may be regarded as inactive segments and thus darkened for conserving the battery power.

Continuing with the previous discuss of detection of folding, bending, rolling, curving, etc., of flexible screen 230 by detection/segmentation logic 201, once any folds, bends, rolls, and/or curves on flexible screen 230 are detected by one or more capturing/sensing components 221, this information and measurement data may then be forwarded on to marking/dividing logic 211 for further processing. For example, touch logic 203, via touch sensor 231, may detect and measure any changes in the charges around one or more axis areas due to changes in screen pixel proximity in those axis areas which is caused by bending of touch-based flexible screen 230. This measurement data may then be used by marking/dividing logic 211 to recognize division of flexible screen 230 at locations corresponding to the identified axis areas as multiple zones, where these zones are then marked as parts or segments to then be used as separate display segments for displaying different contents on flexible screen 230. This division may be applied or executed by active/inactive logic 213 to darken or turn-off the segments that are regarded as inactive and keep turned-on the segments that are regarded as active.

Similarly, for example, non-touch logic 205, via non-touch sensor 233, may detect and measure any differences or changes in the current charge, over time, around specific areas. This measurement technique includes using non-touch sensor 233 for extraction of small changes in current charges as detected in one or more specific areas over a period of time and continuously measuring any differences detected between previous charges and current charges to identify and regard the one or more specific areas as bend areas or axis areas. This measure of axis areas is used by marking/dividing logic 211 to recognize divisions of flexible screen 230 at locations corresponding to the identified axis areas as multiple zones, where these zones are then marked as parts or segments to then be used as separate display screens for displaying different contents on flexible screen 230, where these divisions are then applied or executed by active/inactive logic 213 to darken inactive segments and keep turned-on active segments of flexible screen 230.

Further, in one embodiment, active/inactive logic 213 may be used to activate the divided and marked segment activating these segments as displays and assigning them their user interfaces. As further illustrated with respect to FIGS. 3A-3D, each segment or side of flexible screen 230 may be used as a separate display screen capable of providing content that may be distinct and different from the contents provided through other segments of flexible screen 230. For example, as illustrated with respect to FIGS. 3A-3D, if flexible screen 230 is bent and divided into two segments, such as 301A-D, 303A-D, 305A one of the two segments may display a website showing local weather details, while, in one embodiment, the other segment may be completely turned-off or darkened or, in another embodiment, show a video relating to the local weather or something entirely different, such as a sports website, a television news channel, a movie, etc., or it may simply be left blank or turned off.

In one embodiment, active/inactive logic 213 activates each segment to enable it to display content or be darkened and turned-off and further, in one embodiment, active/inactive logic 213 assigns a separate user interface to each segment to allow it to play content that may be distinguished from contents of other segments on the same flexible screen 230. Moreover, in one embodiment, contents/preferences logic 215 may be used to facilitate each segment to provide its contents through its assigned user interface. For example, upon having the segments activated and assigned their corresponding interfaces by user interface 217, each segment may then be facilitated to accept any amount and type of content and with the ability to display the content as facilitated by contents/preferences logic 215.

In one embodiment, contents/preferences logic 215 is further to allow the user to set their own preferences on how they wish to use the multiple segments of flexible screen 230. For example, in one embodiment, the user may set predefined criteria for triggering the darkening or turning off of one or more sides of flexible screen 230 based on, for example, certain touches, lack of touches, gestures, gazing of the eyes, tilting of the head, etc. Further, for example and in another embodiment, the user may choose to predefine or preset the different types or categories of contents they wish to have displayed on different segments of flexible screen 230. For example, a user who is an investor or works in the finance industry may wish to have the stock market numbers displayed at all time on one side of a folded flexible screen 230 while keeping the other side darkened for saving battery power. Similarly, the user may wish to have family photos along with current time and weather displayed at all time on one segment of flexible screen 230, while keeping the other segment turned-off or use as necessitated, and/or the like. In some embodiment, users may wish to have all segments display a single content, such as a movie, etc., such as having portions of a single movie screen collectively displayed using multiple segments, etc. It is contemplated that embodiments are not limited to any of the preferences described above and that users may choose to set and reset any number and type of personal settings, as desired or necessitated.

In some embodiments and for example, active/inactive logic 213, contents/preferences logic 215, user interface 217, etc., allows for interaction and communication between two or more segments, allowing the user to efficiently perform multiple tasks (referred to as “multitasking”) based on user preferences. Similarly, in case of computing device 100 being a smartphone or a tablet computer with bending abilities, computing device 100 along with flexible screen 230 may be bent such that active/inactive logic 213 may allow for one side or segment to stay active with any contents where the other segment may be kept darkened, based on the user's preference settings, and further allow for dividing different widgets on each segment of multiple segments of flexible screen 230.

Further, as illustrated with reference to FIGS. 3A-3D, segmentation of flexible screen 230 may further allow for partitioning of flexible screen 230 into different segments providing additional screens which may be extremely valuable in certain activities, such as gaming, such as, in case of a war game, one segment may display the game and its progression, while another segment may display weapons menu to efficiently and easily control and play the game, and yet other segments may remain inactive and dark to preserve the battery life while providing enhanced gaming experience to the user.

In one embodiment, flexibility mechanism 110 provides for a novel technique for identifying one or more segments of flexible screen 290 that are regarded as inactive and thus can be turned off to not only save valuable battery life for computing device 100, but also secure new usages for the one or more segments of flexible screen 290 that are still active. However, it is contemplated that a segment that is regarded as inactive may be accidently touched by the user and thus, in one embodiment, one or more components of flexibility mechanism 110, such as touch interpretation logic 205, movement interpretation logic 207, etc., may be used to identify the touch or any movement causing the touch, etc., as detected by touch sensors 231, movement sensors 235, etc., respectively, may be regarded as accidental and consequently, ignored. For example, certain criteria or parameters may be used to distinguish an intentional touch from an accidental touch, such as a touch to last a minimum amount of time (e.g., 3 seconds, etc.) to be intentional or the movement is to be sustained for a period of time (such as to distinguish between falling down and laying down, etc.) as facilitated by one or more of interpretation components 203, 205, 207, 209, etc.

It is contemplated that embodiments are not limited to any particular number or type of use cases described throughout this document, such as with regard to FIGS. 3A-3D. For example, the battery saving may be ad hoc, such as when computing device 100 is low on battery, the inactive segment of flexible screen 230 may be automatically darkened to preserve the remaining battery power. Similarly, other more specific use cases may include (without limitation): 1) in case of the user viewing a news website on flexible screen 230, as illustrated in FIG. 3A, the user may fold computing device 100 such that to read specific type of contents, such as headlines, news flash, etc., while fold away the other more detailed contents on a segment that may be darkened or turned off; 2) with regard to online shopping websites, as shown in FIG. 3B, the user may choose to read a product description which may be on one side of the application by keeping that segment of flexible screen 230 up and active, while folding away the other contents of the website to save battery; and 3) when surfing a cooking website, as shown in FIG. 3C, or other similar entertainment websites (e.g., games, etc.), the user may focus on one portion of the contents on the website on a segment of flexible screen 230 and fold away other contents to save battery life; and/or the like.

Communication/compatibility logic 219 may be used to facilitate dynamic communication and compatibility between computing device 100 and any number and type of other computing devices (such as wearable computing devices, mobile computing devices, desktop computers, server computing devices, etc.), processing devices (e.g., central processing unit (CPU), graphics processing unit (GPU), etc.), capturing/sensing components 221 (e.g., capacitor touch sensors, current delta sensors, non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, databases and/or data sources (such as data storage devices, hard drives, solid-state drives, hard disks, memory cards or devices, memory circuits, etc.), networks (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and the like, may be referenced interchangeably and include, by way of example, software, hardware, and/or any combination of software and hardware, such as firmware. Further, any use of a particular brand, word, term, phrase, name, and/or acronym, such as “flexible display screen”, “flexible screen”, “segmentation”, “segment”, “zone”, “side”, “turned-on”, “turned-off”, “darkened”, “active”, “inactive”, “bend”, “roll”, curve“, “touch”, “non-touch”, “smart glass”, “wearable device”, etc., should not be read to limit embodiments to software or devices that carry that label in products or in literature external to this document.

It is contemplated that any number and type of components may be added to and/or removed from flexibility mechanism 110 to facilitate various embodiments including adding, removing, and/or enhancing certain features. For brevity, clarity, and ease of understanding of flexibility mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates a bending scenario 300A of a flexible display screen 230 according to one embodiment. As an initial mater, for the sake of brevity, clarity, and ease of understanding, many of the processes and components discussed above with respect to FIGS. 1-2 may not be discussed or repeated hereafter. Further, it is contemplated and to be noted, as previously described with reference to FIGS. 1-2, flexible screen 230 may be part of computing device 100, such as a smartphone, a tablet computer, a laptop computer, etc., or may be a standalone device, such as a smart window, etc.; accordingly, for brevity, merely flexible screen 230 is discussed hereafter.

In the illustrated embodiment, flexible screen 230 is bent into two parts like a folder, where two parts represent two segments 301A and 303A of flexible screen 230. For example, flexible screen 230 may be used for display an online news application such that a first segment 301A is regarded as an active segment shown the news contents, where a second segment 303A is turned the other way and out of sight and thus, using one or more components of flexible mechanism 110 of FIG. 2, the second segment 303A is turned dark or turned-off to save the valuable battery power while providing enhanced user experience through the active first segment 301A.

FIG. 3B illustrates a bending scenario 300B of a flexible display screen 230 according to one embodiment. As an initial mater, for the sake of brevity, clarity, and ease of understanding, many of the processes and components discussed above with respect to FIGS. 1-3A may not be discussed or repeated hereafter. Further, it is contemplated and to be noted, as previously described with reference to FIGS. 1-2, flexible screen 230 may be part of computing device 100, such as a smartphone, a tablet computer, a laptop computer, etc., or may be a standalone device, such as a smart window, etc.; accordingly, for brevity, merely flexible screen 230 is discussed hereafter.

In the illustrated embodiment, flexible screen 230 is bent into two parts like a folder, where two parts represent two segments 301B and 303B of flexible screen 230. For example, flexible screen 230 may be used for display an online shopping application such that a first segment 301B is regarded as an active segment shown the shopping contents, where a second segment 303B is turned the other way and out of sight and thus, using one or more components of flexible mechanism 110 of FIG. 2, the second segment 303B is turned dark or turned-off to save the valuable battery power while providing enhanced user experience through the active first segment 301B.

FIG. 3C illustrates a bending scenario 300C of a flexible display screen 230 according to one embodiment. As an initial mater, for the sake of brevity, clarity, and ease of understanding, many of the processes and components discussed above with respect to FIGS. 1-3B may not be discussed or repeated hereafter. Further, it is contemplated and to be noted, as previously described with reference to FIGS. 1-2, flexible screen 230 may be part of computing device 100, such as a smartphone, a tablet computer, a laptop computer, etc., or may be a standalone device, such as a smart window, etc.; accordingly, for brevity, merely flexible screen 230 is discussed hereafter.

In the illustrated embodiment, flexible screen 230 is bent into two parts like a folder, where two parts represent two segments 301C and 303C of flexible screen 230. For example, flexible screen 230 may be used for display an online cooking application such that a first segment 301C is regarded as an active segment shown the cooking contents, where a second segment 303C is turned the other way and out of sight and thus, using one or more components of flexible mechanism 110 of FIG. 2, the second segment 303C is turned dark or turned-off to save the valuable battery power while providing enhanced user experience through the active first segment 301C.

FIG. 3D illustrates a bending scenario 300D of a flexible display screen 230 according to one embodiment. As an initial mater, for the sake of brevity, clarity, and ease of understanding, many of the processes and components discussed above with respect to FIGS. 1-3C may not be discussed or repeated hereafter. Further, it is contemplated and to be noted, as previously described with reference to FIGS. 1-2, flexible screen 230 may be part of computing device 100, such as a smartphone, a tablet computer, a laptop computer, etc., or may be a standalone device, such as a smart window, etc.; accordingly, for brevity, merely flexible screen 230 is discussed hereafter.

For example and in one embodiment, flexible screen 230 of any of FIGS. 3A-3C may now be bent into three parts like a multi-leaf folder, where three parts represent three segments 301D, 303D, and 305A of flexible screen 230. For example and in one embodiment, as described with reference to FIG. 2 and shown with reference to FIG. 3E, the user's holding pattern as shown by the user's hands 311A, 311B may be detected by one or more sensors/components, such as touch sensors 231, cameras, etc., of capturing/sensing components 221 which may then be interpreted by, for example, gesture logic 209 of FIG. 2 to determine the two segments, such as segments 301D and 303D, that the user is holding to be regarded as the active segments, while the remaining segment, such as segment 305A, that is not being held or gazed upon by the user may be regarded as an inactive segment and turned-off to preserve the valuable power while providing enhanced user experience through active segments 301D, 303D.

FIG. 3E illustrates a natural holding gesture. As illustrated, it is considered natural for a user to hold something, such as bend folder 351, in one hand, where the user's thumb 357 of the user's hand 355 is conventionally placed on the active side, such as side 353, of folder 351, while the fingers of the user's hand 355 are placed on the turned or inactive side of folder 351.

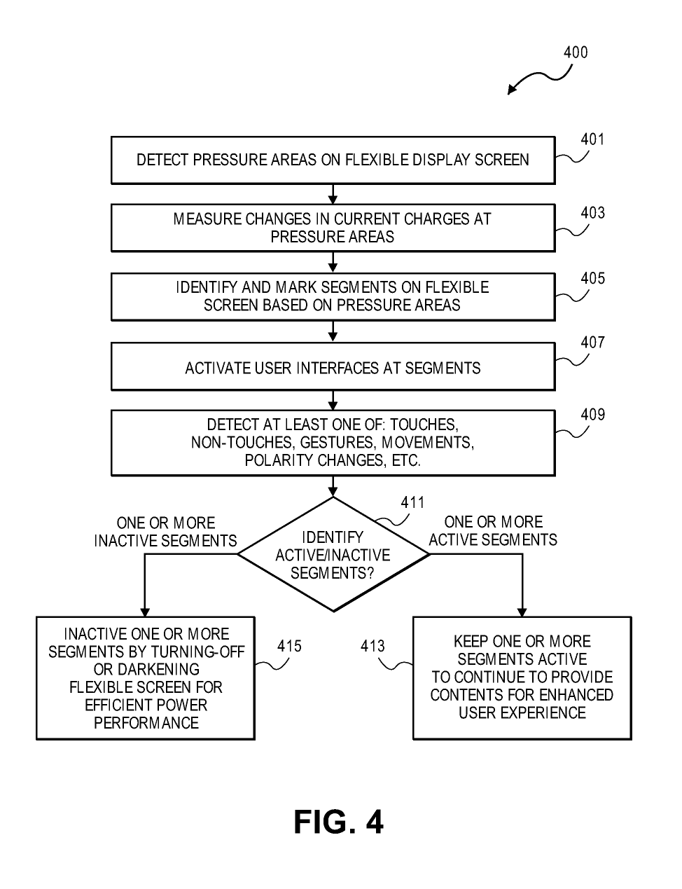

FIG. 4 illustrates a method 400 for facilitating increased user experience and efficient power performance using intelligent segmentation on flexible display screens according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed by flexibility mechanism 110 of FIGS. 1-2. The processes of method 400 are illustrated in linear sequences for brevity and clarity in presentation; however, it is contemplated that any number of them can be performed in parallel, asynchronously, or in different orders. For brevity, many of the details discussed with reference to FIGS. 1-3E may not be discussed or repeated hereafter.

Method 400 may begin with block 401 with detection of pressure areas on a flexible display screen, where the pressure areas refer to those areas of flexible screen where one or more acts of folding, bending, rolling, curving, etc., may be applied. For example, a user trying to fold the flexible screen into two or more segments as illustrated with reference to FIGS. 3A-3D may cause the areas where the fold are applied to be regarded as pressure areas where, for example, current charges at one or more axis may be measured. As described with reference to FIG. 2, in one embodiment, in case of the flexible screen being a touch screen, touch logic 203 may be used to facilitate one or more touch sensor(s) 231 (e.g., touch capacitor sensors) detect and identify any changes in the current charge around the one or more axis areas where the folding, bending, rolling, and/or curving of the flexible screen takes place, such as when the pixel proximity of the flexible screen changes around these one or more axis areas due to at least one of bending, rolling, and/or curving of the flexible screen. In one embodiment, touch logic 203 may further facilitate the one or more touch sensor(s) 231 (e.g., touch capacitor sensors) of FIG. 2 to measure these changes or differences in the current charges around the one or more axis areas to, for example, determine capacitance or change in capacitance of the one or more axis areas.

Similarly, as further described with reference to FIG. 2, non-touch logic 205 may be used to facilitate one or more non-touch sensor(s) 233 (e.g., current delta sensors) to detect and extract current changes in and around one or more specific areas (e.g., axis areas) of the flexible screen over a period of time seeking an indication of at least one of folding, bending, rolling, and/or curving of the flexible display screen. In one embodiment, as described with reference to FIG. 2, non-touch logic 205 may be further used to facilitate non-touch sensor(s) 233 (e.g., current delta sensors) to measure any changes in the current charges in and around the one or more specific areas of the flexible screen that indicates, for example, bending of the flexible screen, where this measuring includes detecting differences in charges by comparing one or more present current charges with one or more previous current charges over a period of time.

At block 403, any changes in current charges at the one or more pressure areas are measured, wherein these measurements are then used to identify zones over the flexible screen. At block 405, portions within the zones are identified and marked as segments. At block 407, user interfaces associated with the segments are activated for providing the user the ability to use each segment as a separate display screen within the larger flexible screen.

In one embodiment, at block 409, as described with reference to FIG. 2, at least one of gestures, movements, touches, lack of touches, capacitance/current changes, etc., are detected related to the segments of the flexible screen. At block 411, in one embodiment, a determination is made as to whether one or more of the segments are active (e.g., segments being actively used by the user as identified using one or more processes of block 409) and/or one or more segments are inactive (e.g., segments not being used by the user as identified using one or more processes of block 409). At block 413, with regard to one or more segments identified as active, such segments and their corresponding user interfaces remain active and continue to provide the requested contents to the user for enhanced user experience. At block 415, with regard to one or more segments identified as inactive, such segments and their corresponding user interfaces are turned off and/or darkened to conserve the power (e.g., preserve battery life).

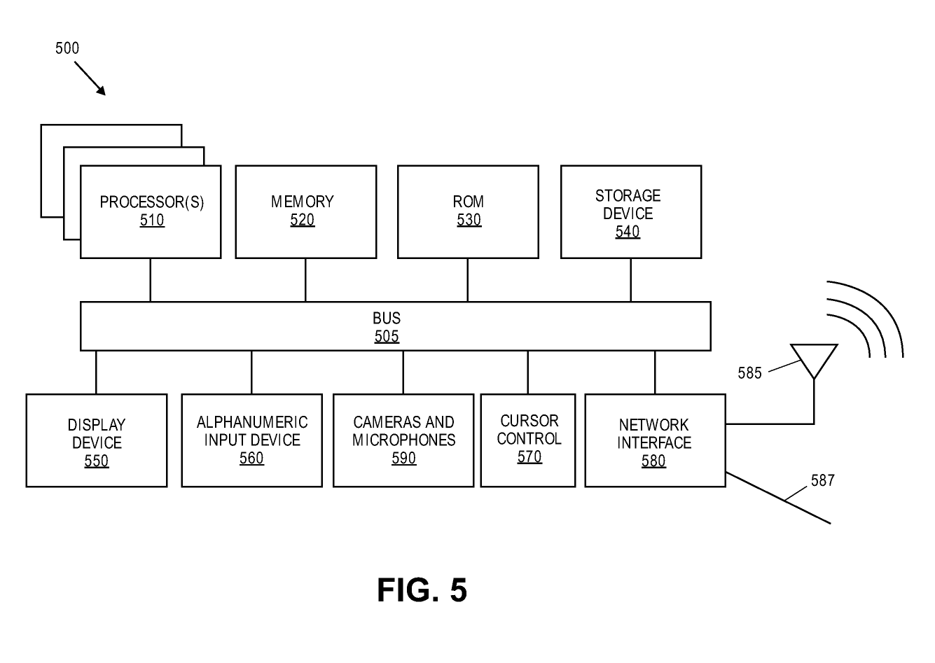

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

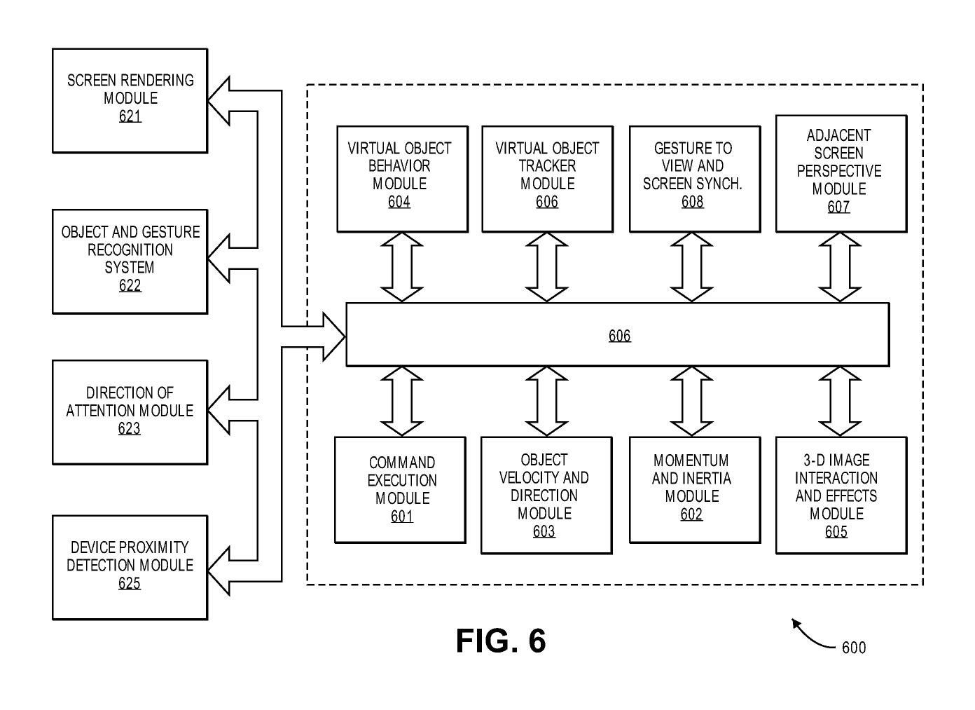

FIG. 6 illustrates an embodiment of a computing environment 600 capable of supporting the operations discussed above. The modules and systems can be implemented in a variety of different hardware architectures and form factors including that shown in FIG. 9.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and harm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System, using one or more cameras, without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three dimensional space in a vicinity of an display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate increased user experience and efficient power performance using intelligent segmentation on flexible display screens, comprising: a flexible display screen; detection/segmentation logic to detect a plurality of segments on the flexible display screen; one or more capturing/sensing components to detect at least one of a touch, a lack of touch, a movement, and a gesture relative to the plurality of segments; touch interpretation logic to interpret the touch to determine one or more active segments or one or more inactive segments of the plurality of segments; and active/inactive logic to turn-off the one or more inactive segments and keep active the one or more active segments of the plurality of segments of the flexible display screen.

Example 2 includes the subject matter of Example 1, further comprising non-touch interpretation logic to interpret the lack of touch to determine the one or more active segments or the one or more inactive segments of the plurality of segments of the flexible display screen.

Example 3 includes the subject matter of Example 1 or 2, further comprising movement interpretation logic to interpret the movement to determine the one or more active segments or the one or more inactive segments of the plurality of segments of the flexible display screen.

Example 4 includes the subject matter of Example 1 or 2, further comprising gesture interpretation logic to interpret the gesture to determine the one or more active segments or the one or more inactive segments of the plurality of segments of the flexible display screen.

Example 5 includes the subject matter of Example 1, wherein the touch comprises one or more touches of a user on the flexible display screen, wherein the one or more touches include a touch indicating a natural holding patter, wherein the movement comprises one or more movements of the user or the flexible display screen as detected by at least one of an accelerometer and a gyroscope of the capturing/sensing components, and wherein the gesture comprises one or more gestures of the user, wherein the one or more gestures including at least one of a tilting of a head of the user and a gazing of eyes of the user.

Example 6 includes the subject matter of Example 1, further comprising: one or more touch sensors of the one or more capturing/sensing components to detect alterations in current in and around one or more areas of the flexible display screen, wherein the alterations represent pressure being applied to cause at least one of folding, bending, rolling, and curving of the flexible display screen into the plurality of segments; marking/dividing logic to identify and mark the plurality of segments; and contents/preferences logic to facilitate displaying of contents via the one or more active segments of the flexible display screen, wherein the contents/preferences logic is further to facilitate the turning-off of the one or more inactive segments.

Example 7 includes the subject matter of Example 1 or 6, further comprising: one or more non-touch sensors of the one or more capturing/sensing components to detect current charges, over a period of time, in and around the one or more areas of the flexible display screen, wherein the non-touch interpretation logic to measure gradual changes in the current charges over the period of time by detecting and comparing one or more present current charges with one or more previous current charges, wherein the gradual changes represent the applied pressure; and a plurality of user interfaces associated with the plurality of segments, wherein a user interface is associated with each of the plurality of segments and is further to facilitate interactivity amongst the plurality of segments.

Example 8 includes the subject matter of Example 1, wherein the flexible display screen comprises at least one of a standalone flexible display screen and a device-based flexible display screen mounted on a computing device including at least one of a wearable device, smart window, smart mobile device, laptop computer, desktop computer, and server computer, wherein the device-based flexible display screen includes an extension screen of a main display screen of the computing device.

Some embodiments pertain to Example 9 that includes a method for facilitating dynamic detection and intelligent use of segmentation on flexible display screens, comprising: detecting a plurality of segments on a flexible display screen; detecting, via one or more capturing/sensing components, at least one of a touch, a lack of touch, a movement, and a gesture relative to the plurality of segments; interpreting the touch to determine one or more active segments or one or more inactive segments of the plurality of segments; and turning-off the one or more inactive segments and keep active the one or more active segments of the plurality of segments of the flexible display screen.

Example 10 includes the subject matter of Example 9, further comprising interpreting the lack of touch to determine the one or more active segments or the one or more inactive segments of the plurality of segments of the flexible display screen.

Example 11 includes the subject matter of Example 9 or 10, further comprising interpreting the movement to determine the one or more active segments or the one or more inactive segments of the plurality of segments of the flexible display screen.

Example 12 includes the subject matter of Example 9 or 10, further comprising interpreting the gesture to determine the one or more active segments or the one or more inactive segments of the plurality of segments of the flexible display screen.

Example 13 includes the subject matter of Example 9, wherein the touch comprises one or more touches of a user on the flexible display screen, wherein the one or more touches include a touch indicating a natural holding patter, wherein the movement comprises one or more movements of the user or the flexible display screen as detected by at least one of an accelerometer and a gyroscope of the capturing/sensing components, and wherein the gesture comprises one or more gestures of the user, wherein the one or more gestures including at least one of a tilting of a head of the user and a gazing of eyes of the user.

Example 14 includes the subject matter of Example 9, further comprising: detecting, via one or more touch sensors of the one or more capturing/sensing components, alterations in current in and around one or more areas of the flexible display screen, wherein the alterations represent pressure being applied to cause at least one of folding, bending, rolling, and curving of the flexible display screen into the plurality of segments; identifying and marking the plurality of segments; and facilitating displaying of contents via the one or more active segments of the flexible display screen, wherein facilitating further includes turning-off of the one or more inactive segments.

Example 15 includes the subject matter of Example 9 or 14, further comprising: detecting, via one or more non-touch sensors of the one or more capturing/sensing components, current charges, over a period of time, in and around the one or more areas of the flexible display screen; measuring gradual changes in the current charges over the period of time by detecting and comparing one or more present current charges with one or more previous current charges, wherein the gradual changes represent the applied pressure; and associating a plurality of user interfaces with the plurality of segments, wherein a user interface is associated with each of the plurality of segments and is further to facilitate interactivity amongst the plurality of segments.

Example 16 includes the subject matter of Example 9, wherein the flexible display screen comprises at least one of a standalone flexible display screen and a device-based flexible display screen mounted on a computing device including at least one of a wearable device, smart window, smart mobile device, laptop computer, desktop computer, and server computer, wherein the device-based flexible display screen includes an extension screen of a main display screen of the computing device.

Example 17 includes at least one machine-readable medium comprising a plurality of instructions, when executed on a computing device, to implement or perform a method or realize an apparatus as claimed in any preceding examples, embodiments, or claims.

Example 18 includes at least one non-transitory or tangible machine-readable medium comprising a plurality of instructions, when executed on a computing device, to implement or perform a method or realize an apparatus as claimed in any preceding examples, embodiments, or claims.

Example 19 includes a system comprising a mechanism to implement or perform a method or realize an apparatus as claimed in any preceding examples, embodiments, or claims.

Example 20 includes an apparatus comprising means to perform a method as claimed in any preceding examples, embodiments, or claims.

Example 21 includes a computing device arranged to implement or perform a method or realize an apparatus as claimed in any preceding examples, embodiments, or claims.

Example 22 includes a communications device arranged to implement or perform a method or realize an apparatus as claimed in any preceding examples, embodiments, or claims.

Some embodiments pertain to Example 23 includes a system comprising a storage device having instructions, and a processor to execute the instructions to facilitate a mechanism to perform one or more operations comprising: detecting a plurality of segments on a flexible display screen; detecting, via one or more capturing/sensing components, at least one of a touch, a lack of touch, a movement, and a gesture relative to the plurality of segments; interpreting the touch to determine one or more active segments or one or more inactive segments of the plurality of segments; and turning-off the one or more inactive segments and keep active the one or more active segments of the plurality of segments of the flexible display screen.

Example 24 includes the subject matter of Example 23, wherein the one or more operations further comprise interpreting the lack of touch to determine the one or more active segments or the one or more inactive segments of the plurality of segments of the flexible display screen.

Example 25 includes the subject matter of Example 23 or 24, wherein the one or more operations further comprise interpreting the movement to determine the one or more active segments or the one or more inactive segments of the plurality of segments of the flexible display screen.

Example 26 includes the subject matter of Example 23 or 24, wherein the one or more operations further comprise interpreting the gesture to determine the one or more active segments or the one or more inactive segments of the plurality of segments of the flexible display screen.

Example 27 includes the subject matter of Example 23, wherein the touch comprises one or more touches of a user on the flexible display screen, wherein the one or more touches include a touch indicating a natural holding patter, wherein the movement comprises one or more movements of the user or the flexible display screen as detected by at least one of an accelerometer and a gyroscope of the capturing/sensing components, and wherein the gesture comprises one or more gestures of the user, wherein the one or more gestures including at least one of a tilting of a head of the user and a gazing of eyes of the user.

Example 28 includes the subject matter of Example 23, wherein the one or more operations further comprise: detecting, via one or more touch sensors of the one or more capturing/sensing components, alterations in current in and around one or more areas of the flexible display screen, wherein the alterations represent pressure being applied to cause at least one of folding, bending, rolling, and curving of the flexible display screen into the plurality of segments; identifying and marking the plurality of segments; and facilitating displaying of contents via the one or more active segments of the flexible display screen, wherein facilitating further includes turning-off of the one or more inactive segments.

Example 29 includes the subject matter of Example 23 or 28, wherein the one or more operations further comprise: detecting, via one or more non-touch sensors of the one or more capturing/sensing components, current charges, over a period of time, in and around the one or more areas of the flexible display screen; measuring gradual changes in the current charges over the period of time by detecting and comparing one or more present current charges with one or more previous current charges, wherein the gradual changes represent the applied pressure; and associating a plurality of user interfaces with the plurality of segments, wherein a user interface is associated with each of the plurality of segments and is further to facilitate interactivity amongst the plurality of segments.

Example 30 includes the subject matter of Example 23, wherein the flexible display screen comprises at least one of a standalone flexible display screen and a device-based flexible display screen mounted on a computing device including at least one of a wearable device, smart window, smart mobile device, laptop computer, desktop computer, and server computer, wherein the device-based flexible display screen includes an extension screen of a main display screen of the computing device.

Some embodiments pertain to Example 31 includes an apparatus comprising: means for detecting a plurality of segments on a flexible display screen; means for detecting, via one or more capturing/sensing components, at least one of a touch, a lack of touch, a movement, and a gesture relative to the plurality of segments; means for interpreting the touch to determine one or more active segments or one or more inactive segments of the plurality of segments; and means for turning-off the one or more inactive segments and keep active the one or more active segments of the plurality of segments of the flexible display screen.

Example 32 includes the subject matter of Example 31, wherein the one or more operations further comprise means for interpreting the lack of touch to determine the one or more active segments or the one or more inactive segments of the plurality of segments of the flexible display screen.

Example 33 includes the subject matter of Example 31 or 32, wherein the one or more operations further comprise means for interpreting the movement to determine the one or more active segments or the one or more inactive segments of the plurality of segments of the flexible display screen.

Example 34 includes the subject matter of Example 31 or 32, wherein the one or more operations further comprise means for interpreting the gesture to determine the one or more active segments or the one or more inactive segments of the plurality of segments of the flexible display screen.

Example 35 includes the subject matter of Example 31, wherein the touch comprises one or more touches of a user on the flexible display screen, wherein the one or more touches include a touch indicating a natural holding patter, wherein the movement comprises one or more movements of the user or the flexible display screen as detected by at least one of an accelerometer and a gyroscope of the capturing/sensing components, and wherein the gesture comprises one or more gestures of the user, wherein the one or more gestures including at least one of a tilting of a head of the user and a gazing of eyes of the user.

Example 36 includes the subject matter of Example 31, wherein the one or more operations further comprise: means for detecting, via one or more touch sensors of the one or more capturing/sensing components, alterations in current in and around one or more areas of the flexible display screen, wherein the alterations represent pressure being applied to cause at least one of folding, bending, rolling, and curving of the flexible display screen into the plurality of segments; means for identifying and marking the plurality of segments; and means for facilitating displaying of contents via the one or more active segments of the flexible display screen, wherein facilitating further includes turning-off of the one or more inactive segments.

Example 37 includes the subject matter of Example 31 or 36, wherein the one or more operations further comprise: means for detecting, via one or more non-touch sensors of the one or more capturing/sensing components, current charges, over a period of time, in and around the one or more areas of the flexible display screen; means for measuring gradual changes in the current charges over the period of time by detecting and comparing one or more present current charges with one or more previous current charges, wherein the gradual changes represent the applied pressure; and means for associating a plurality of user interfaces with the plurality of segments, wherein a user interface is associated with each of the plurality of segments and is further to facilitate interactivity amongst the plurality of segments.

Example 38 includes the subject matter of Example 31, wherein the flexible display screen comprises at least one of a standalone flexible display screen and a device-based flexible display screen mounted on a computing device including at least one of a wearable device, smart window, smart mobile device, laptop computer, desktop computer, and server computer, wherein the device-based flexible display screen includes an extension screen of a main display screen of the computing device.

Example 39 includes at least one non-transitory or tangible machine-readable medium comprising a plurality of instructions, when executed on a computing device, to implement or perform a method as claimed in any of examples, embodiments, or claims 9-16.

Example 40 includes at least one machine-readable medium comprising a plurality of instructions, when executed on a computing device, to implement or perform a method as claimed in any of examples, embodiments, or claims 9-16.

Example 41 includes a system comprising a mechanism to implement or perform a method as claimed in any of examples, embodiments, or claims 9-16.

Example 42 includes an apparatus comprising means for performing a method as claimed in any of examples, embodiments, or claims 9-16.

Example 43 includes a computing device arranged to implement or perform a method as claimed in any of examples, embodiments, or claims 9-16.

Example 44 includes a communications device arranged to implement or perform a method as claimed in any of examples, embodiments, or claims 9-16.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
a flexible display screen;
detection/segmentation logic to detect a plurality of segments on the flexible display screen;
one or more capturing/sensing components to detect at least one of a touch, a lack of touch, a movement, and a gesture relative to the plurality of segments;
touch interpretation logic to interpret the touch to determine one or more active segments or one or more inactive segments of the plurality of segments; and
active/inactive logic to turn-off the one or more inactive segments and keep active the one or more active segments of the plurality of segments of the flexible display screen.

2. The apparatus of claim 1, further comprising non-touch interpretation logic to interpret the lack of touch to determine the one or more active segments or the one or more inactive segments of the plurality of segments of the flexible display screen.

3. The apparatus of claim 1, further comprising movement interpretation logic to interpret the movement to determine the one or more active segments or the one or more inactive segments of the plurality of segments of the flexible display screen.

4. The apparatus of claim 1, further comprising gesture interpretation logic to interpret the gesture to determine the one or more active segments or the one or more inactive segments of the plurality of segments of the flexible display screen.

5. The apparatus of claim 1, wherein the touch comprises one or more touches of a user on the flexible display screen, wherein the one or more touches include a touch indicating a natural holding patter, wherein the movement comprises one or more movements of the user or the flexible display screen as detected by at least one of an accelerometer and a gyroscope of the capturing/sensing components, and wherein the gesture comprises one or more gestures of the user, wherein the one or more gestures including at least one of a tilting of a head of the user and a gazing of eyes of the user.

6. The apparatus of claim 1, further comprising:
one or more touch sensors of the one or more capturing/sensing components to detect alterations in current in and around one or more areas of the flexible display screen, wherein the alterations represent pressure being applied to cause at least one of folding, bending, rolling, and curving of the flexible display screen into the plurality of segments;
marking/dividing logic to identify and mark the plurality of segments; and
contents/preferences logic to facilitate displaying of contents via the one or more active segments of the flexible display screen, wherein the contents/preferences logic is further to facilitate the turning-off of the one or more inactive segments.

7. The apparatus of claim 6, further comprising:
one or more non-touch sensors of the one or more capturing/sensing components to detect current charges, over a period of time, in and around the one or more areas of the flexible display screen, wherein the non-touch interpretation logic to measure gradual changes in the current charges over the period of time by detecting and comparing one or more present current charges with one or more previous current charges, wherein the gradual changes represent the applied pressure; and
a plurality of user interfaces associated with the plurality of segments, wherein a user interface is associated with each of the plurality of segments and is further to facilitate interactivity amongst the plurality of segments.

8. The apparatus of claim 1, wherein the flexible display screen comprises at least one of a standalone flexible display screen and a device-based flexible display screen mounted on a computing device including at least one of a wearable device, smart window, smart mobile device, laptop computer, desktop computer, and server computer, wherein the device-based flexible display screen includes an extension screen of a main display screen of the computing device.

9. A method comprising:
detecting a plurality of segments on a flexible display screen;
detecting, via one or more capturing/sensing components, at least one of a touch, a lack of touch, a movement, and a gesture relative to the plurality of segments;
interpreting the touch to determine one or more active segments or one or more inactive segments of the plurality of segments; and
turning-off the one or more inactive segments and keep active the one or more active segments of the plurality of segments of the flexible display screen.

10. The method of claim 9, further comprising interpreting the lack of touch to determine the one or more active segments or the one or more inactive segments of the plurality of segments of the flexible display screen.

11. The method of claim 9, further comprising interpreting the movement to determine the one or more active segments or the one or more inactive segments of the plurality of segments of the flexible display screen.

12. The method of claim 9, further comprising interpreting the gesture to determine the one or more active segments or the one or more inactive segments of the plurality of segments of the flexible display screen.

13. The method of claim 9, wherein the touch comprises one or more touches of a user on the flexible display screen, wherein the one or more touches include a touch indicating a natural holding patter, wherein the movement comprises one or more movements of the user or the flexible display screen as detected by at least one of an accelerometer and a gyroscope of the capturing/sensing components, and wherein the gesture comprises one or more gestures of the user, wherein the one or more gestures including at least one of a tilting of a head of the user and a gazing of eyes of the user.

14. The method of claim 9, further comprising:
detecting, via one or more touch sensors of the one or more capturing/sensing components, alterations in current in and around one or more areas of the flexible display screen, wherein the alterations represent pressure being applied to cause at least one of folding, bending, rolling, and curving of the flexible display screen into the plurality of segments;
identifying and marking the plurality of segments; and
facilitating displaying of contents via the one or more active segments of the flexible display screen, wherein facilitating further includes turning-off of the one or more inactive segments.

15. The method of claim 14, further comprising:
detecting, via one or more non-touch sensors of the one or more capturing/sensing components, current charges, over a period of time, in and around the one or more areas of the flexible display screen;
measuring gradual changes in the current charges over the period of time by detecting and comparing one or more present current charges with one or more previous current charges, wherein the gradual changes represent the applied pressure; and
associating a plurality of user interfaces with the plurality of segments, wherein a user interface is associated with each of the plurality of segments and is further to facilitate interactivity amongst the plurality of segments.

16. The method of claim 9, wherein the flexible display screen comprises at least one of a standalone flexible display screen and a device-based flexible display screen mounted on a computing device including at least one of a wearable device, smart window, smart mobile device, laptop computer, desktop computer, and server computer, wherein the device-based flexible display screen includes an extension screen of a main display screen of the computing device.

17. At least one machine-readable medium comprising a plurality of instructions, executed on a computing device, to facilitate the computing device to perform one or more operations comprising:
detecting a plurality of segments on a flexible display screen;
detecting, via one or more capturing/sensing components, at least one of a touch, a lack of touch, a movement, and a gesture relative to the plurality of segments;
interpreting the touch to determine one or more active segments or one or more inactive segments of the plurality of segments; and
turning-off the one or more inactive segments and keep active the one or more active segments of the plurality of segments of the flexible display screen.

18. The machine-readable medium of claim 17, further comprising interpreting the lack of touch to determine the one or more active segments or the one or more inactive segments of the plurality of segments of the flexible display screen.

19. The machine-readable medium of claim 17, wherein the one or more operations further comprise interpreting the movement to determine the one or more active segments or the one or more inactive segments of the plurality of segments of the flexible display screen.

20. The machine-readable medium of claim 17, wherein the one or more operations further comprise interpreting the gesture to determine the one or more active segments or the one or more inactive segments of the plurality of segments of the flexible display screen.

21. The machine-readable medium of claim 17, wherein the touch comprises one or more touches of a user on the flexible display screen, wherein the one or more touches include a touch indicating a natural holding patter, wherein the movement comprises one or more movements of the user or the flexible display screen as detected by at least one of an accelerometer and a gyroscope of the capturing/sensing components, and wherein the gesture comprises one or more gestures of the user, wherein the one or more gestures including at least one of a tilting of a head of the user and a gazing of eyes of the user.

22. The machine-readable medium of claim 17, wherein the one or more operations further comprise:
detecting, via one or more touch sensors of the one or more capturing/sensing components, alterations in current in and around one or more areas of the flexible display screen, wherein the alterations represent pressure being applied to cause at least one of folding, bending, rolling, and curving of the flexible display screen into the plurality of segments;
identifying and marking the plurality of segments; and
facilitating displaying of contents via the one or more active segments of the flexible display screen, wherein facilitating further includes turning-off of the one or more inactive segments.

23. The machine-readable medium of claim 22, wherein the one or more operations further comprise:
detecting, via one or more non-touch sensors of the one or more capturing/sensing components, current charges, over a period of time, in and around the one or more areas of the flexible display screen;
measuring gradual changes in the current charges over the period of time by detecting and comparing one or more present current charges with one or more previous current charges, wherein the gradual changes represent the applied pressure; and
associating a plurality of user interfaces with the plurality of segments, wherein a user interface is associated with each of the plurality of segments and is further to facilitate interactivity amongst the plurality of segments.

24. The machine-readable medium of claim 17, wherein the flexible display screen comprises at least one of a standalone flexible display screen and a device-based flexible display screen mounted on a computing device including at least one of a wearable device, smart window, smart mobile device, laptop computer, desktop computer, and server computer, wherein the device-based flexible display screen includes an extension screen of a main display screen of the computing device.
